(19) United States
(12) Patent Application Publication
(10) Pub. No.: US 2008/0197122 A1
(43) Pub. Date: Aug. 21, 2008

(54) Combination defroster panel and sunshade for vehicle glass

(76) Inventor: Kenneth Parks Gober, Waco, TX (US)

Correspondence Address: LITMAN LAW OFFICES, LTD., P.O. BOX 15035, CRYSTAL CITY STATION, ARLINGTON, VA, 22215, US

(21) Appl. No.: 12/068,952

(22) Filed: Feb. 13, 2008

Related U.S. Application Data
(60) Provisional application No. 60/902,360, filed on Feb. 21, 2007.

(51) Int. Cl. H05B 3/86; B60J 1/20

(52) U.S. Cl. 219/203; 296/95.1

(57) ABSTRACT

The combination defroster panel and sunshade for vehicle glass includes an electrically heated element disposed upon one side of a rigid panel and a reflective surface disposed upon the opposite side of the panel. The device is placed adjacent to the interior surface of the window glass of a vehicle for operation. The panel may be placed with the heating element facing the interior surface of the glass, and electrical power (battery, power grid, etc.) provided to melt ice and/or snow from the exterior of the glass and/or to evaporate condensation from the interior surface of the glass. Alternatively, the device may be placed with the reflective surface facing the interior of the glass, to reduce the interior temperature of the vehicle. The combination panel may be formed as a single rigid panel, or, alternatively, as a plurality of smaller panels hinged together to facilitate storage.

### CROSS-REFERENCE TO RELATED APPLICATION

This application claims the benefit of U.S. Provisional Patent Application Ser. No. 60/902,360, filed Feb. 21, 2007.

### BACKGROUND OF THE INVENTION

1. Field of the Invention

The present invention relates generally to vehicle sunscreens and to vehicle defroster panels. More particularly, the present invention relates to a combination defroster panel and sunshade for vehicle glass that provides an electrically heated defroster disposed upon one side of a panel in combination with a reflective sunshade on the opposite surface of the panel.

2. Description of the Related Art

Motor vehicles, such as automobiles, light trucks and vans, etc. are operated in all kinds of weather extremes in year round operation in most areas of the U.S. As a result, they see conditions from snow and ice, to extreme heat, which can exceed 150° Fahrenheit in a closed car parked in the sun on a hot summer day. Obviously, most people attempt to protect their vehicles to the extent possible by parking in the shade or under cover, but in many cases such protected parking is not available. Accordingly, drivers will often purchase reflective sunshades for installation immediately within the windshield glass of a vehicle on a hot summer day, and may apply various covers, tarps and the like to the exterior of the vehicle in order to facilitate ice and snow removal in the winter.

Complete vehicle covers, tarps, and the like are heavy, bulky, and cumbersome, particularly when laden with ice and snow. Even after removing such a cover, the driver of the vehicle is left with the problem of storing the cover. This can be particularly difficult if the vehicle is away from home, and the driver must place the wet, snow and ice laden cover in the vehicle for carriage. As a result, complete vehicle covers have never become particularly popular for the protection of a vehicle that is driven frequently.

The vehicle owner or driver still must face the problem of heat in the summertime, particularly in more southerly latitudes. Complete vehicle covers are not reflective, and are not particularly efficient at preventing heat buildup within the interior of a closed car parked in the sun. Thus, a driver would require some form of reflective sunshade for summer use, in addition to some form of cover or covers for at least the glass areas of the vehicle, if the driver wishes to avoid the chore of removing ice and snow from the vehicle glass in the winter. Obviously, the bulk of a car cover, or some form of cover for the glass areas of the vehicle, in addition to one or more sunshades for summer use, can result in difficulties in storing all of this equipment. This is particularly true for the vehicle owner who does not have a garage or other suitable storage area, e.g., the apartment dweller, etc.

A number of different devices have been developed in the past for clearing the glass of a motor vehicle. An example of such is found in German Patent No. 3,245,746, published on Jun. 14, 1984. According to the English abstract, the device is capable of de-icing window glass in a motor vehicle, but the device illustrated appears to be relatively thick and bulky for such use. No reflectivity is apparent to provide for use of the device as a sunshade.

Japanese Patent No. 4-50,028, published on Feb. 19, 1992, describes (according to the drawings and English abstract) a sun visor having a heating element therein. Various embodiments are shown in the drawings, including some with extension panels to reach substantially across the vertical span of the windshield.

German Patent No. 4,310,871, published on Oct. 6, 1994, describes (according to the drawings and English abstract) a plate having a heating element therein, and a handle extending from the back of the plate. The device is held by the user in the desired area for defrosting.

None of the above inventions or patents, taken singly or in combination, shows the present invention as claimed. Thus, a combination defroster panel and sunshade for vehicle glass solving the aforementioned problems is desired.

### SUMMARY OF THE INVENTION

The combination defroster panel and sunshade for vehicle glass provides a single device that may be placed in the interior of the vehicle adjacent the glass for the removal of ice, snow, and moisture condensation from the exterior of the glass, and which may be reversed to orient a reflective surface toward the glass to reduce the interior temperature of the vehicle in warmer weather. The device comprises a rigid panel having an electric heating element disposed upon one surface, and a reflective material disposed upon the opposite surface. Insulating material may also be applied to the surface with the electric heating element in order to direct most of the heat toward the interior surface of the vehicle glass. In at least one embodiment, the device is formed from a substantially rigid panel that may be divided into a plurality of smaller panels hinged together to facilitate folding and storage of the device. Other panels for smaller glass areas may be formed of a single non-folding panel.

Electrical power for the device may be provided by a variety of conventional sources, e.g., the vehicle's electrical system, a separate rechargeable or single use battery or electrical cell, solar cells, or the local electrical power grid, according to the electrical requirements of the heating element. The device may be secured adjacent to the interior surface of the vehicle window glass by a variety of window attachment mechanisms, e.g., suction cups, mating hook and loop fasteners, mechanical fasteners, etc.

These and other features of the present invention will become readily apparent upon further review of the following specification and drawings.

### BRIEF DESCRIPTION OF THE DRAWINGS

FIG. 1 is an environmental, perspective view of a set of combination defroster panel and sunshade devices for vehicle glass according to the present invention installed within the window glass areas of an automobile and oriented to defrost and deice the glass surfaces.

FIG. 2A is a perspective view of the heating surface or side of a folding embodiment of a combination defroster panel and sunshade according to the present invention.

FIG. 2B is a perspective view of the reflective surface or side the combination defroster panel and sunshade of FIG. 2A.

FIG. 3 is a side elevation view in section of a combination defroster panel and sunshade according to the present invention, showing the various layers or components thereof and alternative attachment and power means.

Similar reference characters denote corresponding features consistently throughout the attached drawings.

### DETAILED DESCRIPTION OF THE PREFERRED EMBODIMENTS

The present invention is a combination defroster panel and sunshade for vehicle glass adapted particularly for use with motor vehicles. The device includes an electrically resistive heating element disposed upon or over one surface, and a reflective coating disposed upon the opposite surface. Thus, the device may be used for melting ice and snow and evaporating condensation from the window glass of a vehicle, or, alternatively, for reflecting radiant energy from the vehicle interior to reduce interior heating within the vehicle, depending upon the orientation of the device when it is placed immediately inside and adjacent to the window glass of the vehicle.

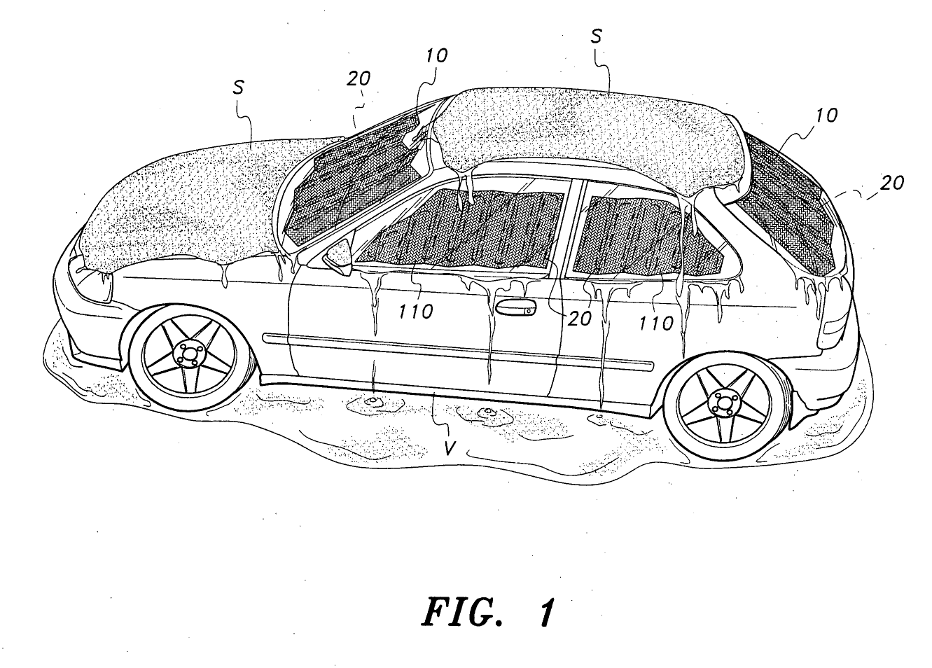

FIG. 1 provides an environmental perspective view of a motor vehicle V having a set of combination panels installed therein. In the example of FIG. 1, front and rear combination panels 10 are placed immediately adjacent to the interior surfaces of the front and rear windshield or window glass of the vehicle V, with additional panels 110 placed immediately adjacent to the interior surfaces of the side glass of the vehicle. The various panels 10 and 110 are oriented with their heat-emitting elements toward the window glass of the vehicle, i.e., facing outwardly, in order to melt ice and snow S from the window glass area of the vehicle V in FIG. 1.

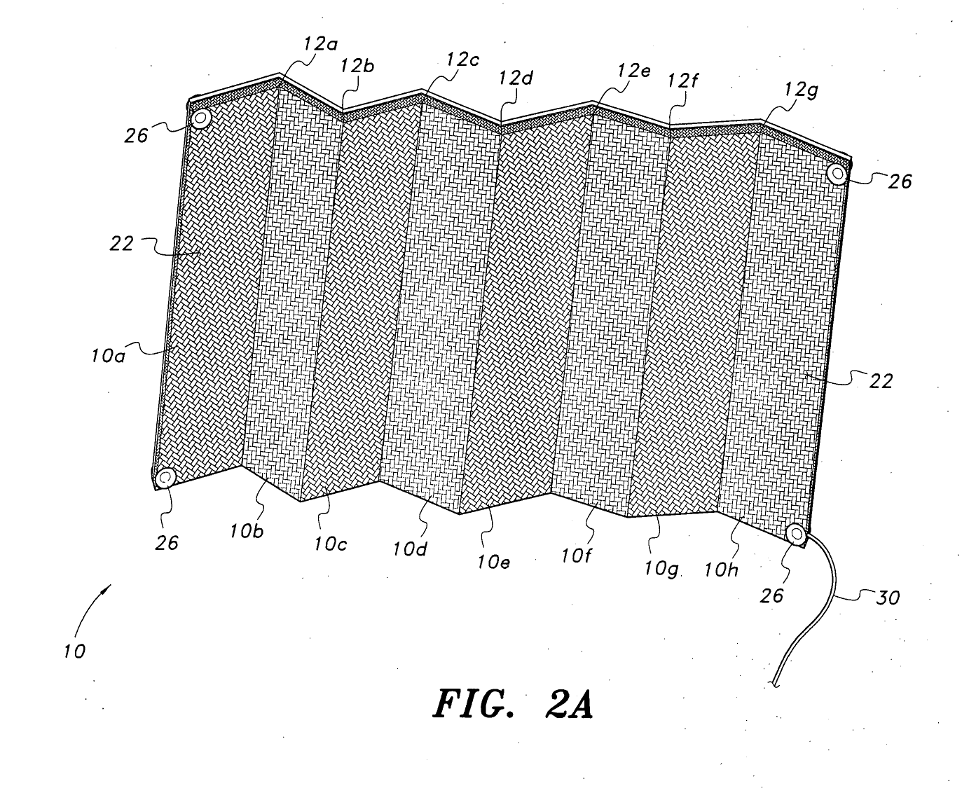

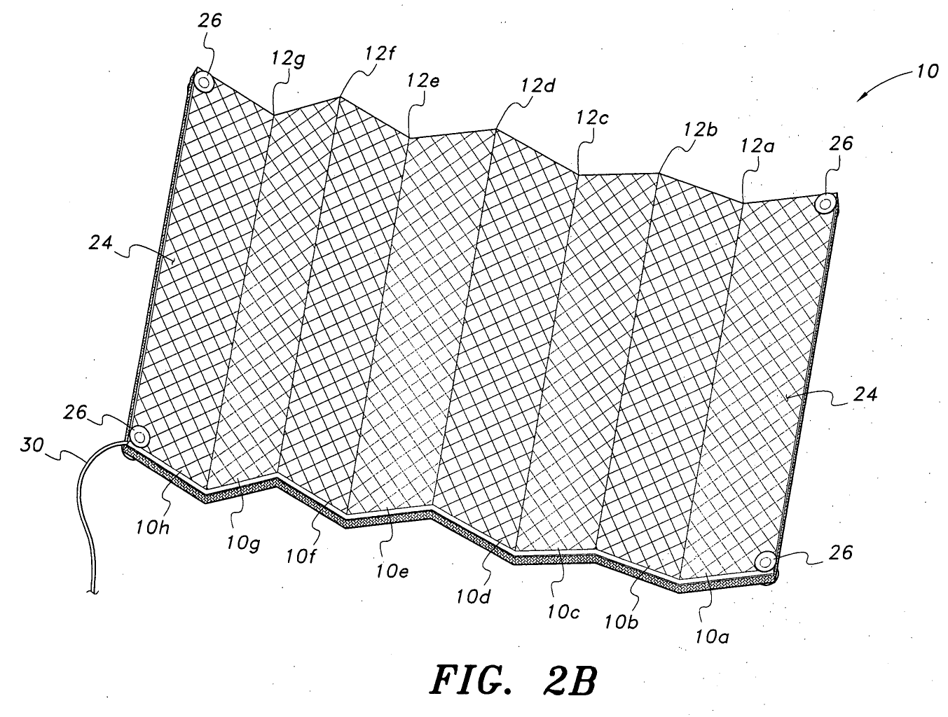

The primary difference between the two different types of panels 10 and 110, other than their size, is that the larger panels 10 are formed of a plurality of smaller panels or sheets 10a, 10b, 10c, etc., which are joined together along a corresponding plurality of parallel hinge lines 12a, 12b, 12c, etc., generally as shown in FIGS. 2A and 2B. This allows the larger panels 10 to be folded for compact storage. The hinges 12a, 12b, etc. may be formed of thin sheets of flexible material bonded to or forming one of the surfaces of the rigid panels, or may alternatively comprise mechanical hinges, as desired. The smaller panels 110 are each formed of a single rigid panel or sheet of material.

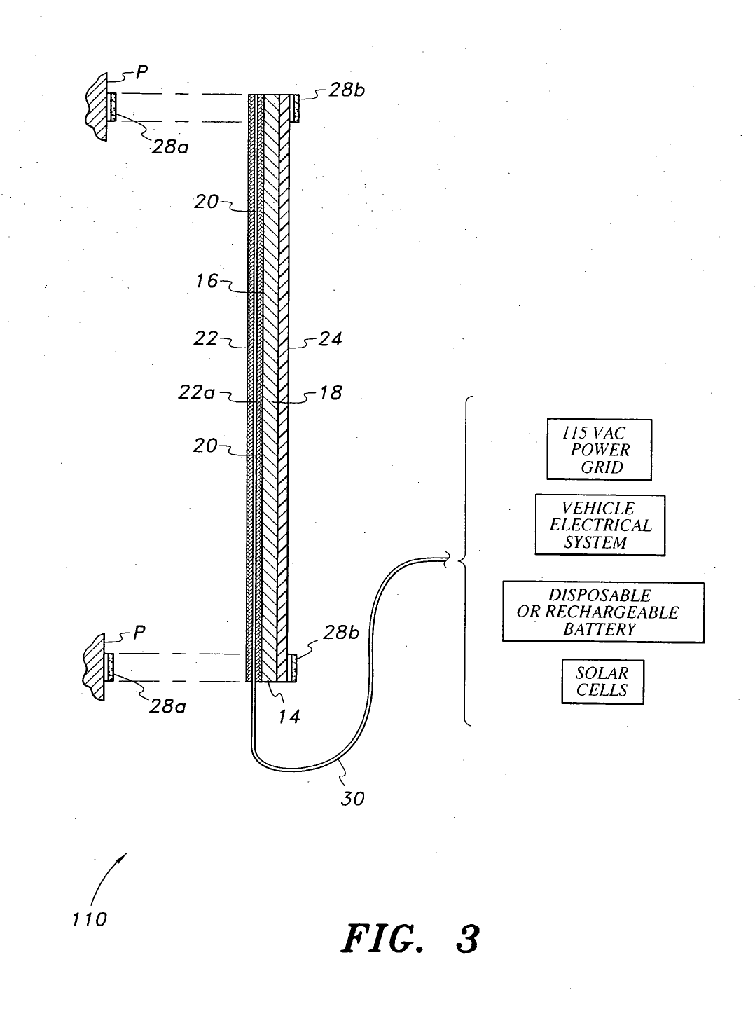

FIG. 3 provides a side elevation view in section of a one of the smaller panels 110, illustrating the various elements that form the assembled panel. It will be understood that the multiple sheet panels 10 include substantially the same elements disposed in the same order. The illustration of a smaller panel 110 in FIG. 3 is provided to simplify the drawing, and to avoid the showing of additional panels extending from the single panel shown. The basic structure of the panel 110 is provided by a rigid panel or sheet of material 14 to which the other components of the device are attached. The rigid panel 14 has a first surface 16 and an opposite second surface 18, with the two surfaces 16 and 18 providing for the attachment of different components thereto for the two different functions of the device. The first surface 16 has an electric heating element 20 disposed thereover, e.g., an electrically resistive wire disposed in a continuous sinusoidal or other path to distribute the element 20 in a closely spaced pattern entirely across the panel 14. The heating element 20 is also shown in broken lines in the panels 10 and 110 of FIG. 1.

A coating or cover of insulating material 22 is preferably applied to the first surface 16 of the panel 14 between the electric heating element 20 and the panel 14. The insulation 22 may be secured to the panel 14 by conventional adhesive or other attachment means as desired. In the embodiment of FIG. 3, the insulating material comprises a woven blanket material with the heating element 20 captured therein, somewhat like a conventional electric blanket or heating pad. The insulating material 22 serves a dual purpose, i.e., the portion 22a between the heating element 20 and panel 14 serves to reduce wasted heat transmission from the heating element 20 toward the interior of the vehicle V when the panels 10, 110 are disposed as shown in FIG. 1 for heating the vehicle glass, with the entire insulating blanket further serving to reduce heat buildup within the vehicle V due to any heat energy transmitted through the panel 10 or 110 when it is positioned or oriented to reflect heat outwardly. The panel orientation displaying or showing the insulating material 22, is provided in FIG. 2A of the drawings.

The opposite second surface 18 of the panel 14 is coated with a highly reflective material or coating 24, with the reflective coating 24 forming one exterior surface of the panel assembly 110 or 10. It will be noted that the thickness of the reflective coating 24 is highly exaggerated in FIG. 3, for clarity in the drawing. The reflective coating 24 may be a highly polished, mirror-like aluminized material or other suitable material for reflecting electromagnetic energy outwardly therefrom, particularly energy in the infrared range. FIG. 2B of the drawings illustrates the panel 10 with its reflective surface or coating 24 displayed. This surface would be placed toward the interior surface of the vehicle window glass in warm weather to reflect heat energy outwardly from the vehicle V.

The combination panel 10 or 110 may be secured adjacent to the interior surface of the vehicle window glass by any of a number of suitable attachment means. In FIGS. 2A and 2B, a series of suction cups 26 are shown at the corners of the panel. It should be noted that the suction cups 26 or other fasteners are disposed upon both sides or surfaces of the panel, i.e., the fasteners extend from the insulation blanket 22 as shown in FIG. 2A, and also from the reflective surface 24 as shown in FIG. 2B. This allows the combination panel 10 or 110 to be oriented with either surface disposed directly adjacent to and facing the inside of the vehicle glass, depending upon the desired function of the device at the time.

FIG. 3 illustrates an alternative panel window attachment means, comprising cooperating hook and loop fabric material (e.g., Velcro®). Hook type material 28a may be adhesively or otherwise secured to a suitable internal structure S of the vehicle, with mating loop pile type material 28b being provided at the appropriate locations on the reflective surface 24 or vice versa. The fastener material 28b need not be provided on the opposite side of the panel 110, as the insulation blanket material 22 thereon provides sufficient engagement or grip with the hook material 28a secured to an internal structural surface or panel P of the vehicle, e.g., surrounding window trim, etc. Other attachment means may be provided, e.g., conventional mechanical snaps, buttons, ties, or other mechanical fastener means, and/or the panel 10 or 110 may be braced between the upper surface of the dash and the interior mirror, etc.

An electrical cord 30 is provided to conduct electrical energy from a suitable source to the electric heating element 20 of the device. Electrical power for the heating element 20 may be provided in any of a number of conventional ways, with some of these means being shown in FIG. 3. For example, conventional 115-volt (nominal) ac power may be provided from the conventional electrical power grid, with the gauge of the electrically resistive element 20 sized correspondingly. Alternatively, lower voltage electrical power may be used, e.g., 12 volts (nominal) from the vehicle electrical system, disposable or rechargeable electrical cells or battery, and/or electrical energy provided from solar cells. As these latter electrical sources provide lower voltage than the 115-volt power grid, the gauge of the resistive element 20 would be reduced accordingly to provide sufficient resistance and heat. Alternatively, an adaptor may be provided to reduce the line voltage to a lower level, enabling the electric heating element 20 to be used with any of the above-noted electrical power sources as desired.

In conclusion, the combination defroster panel and sunshade facilitates the removal of ice, snow, and condensation from vehicle glass surfaces in cold conditions, and also serves to reduce the interior temperature within a vehicle in warmer conditions. The provision of a single panel incorporating both functions greatly simplifies the storage and use of such devices. For use as a sunshade, the panel may simply be placed adjacent the interior of the vehicle glass, with no further action required. For use as a defrosting device, the panel is reversed to place its electrically heated surface facing the interior surface of the glass, with the panel then being connected to a suitable source of electrical power. A conventional timer may be incorporated to obviate the need to leave the electrical power connected for an extended period of time.

The provision of different sizes of panels, and particularly a folding embodiment, allows the purchaser to purchase panels at least generally configured for the various window glass areas of his or her vehicle. Thus, the user of the combination panel can fit the panels closely to the interior surfaces of the vehicle window glass with little or no non-congruent areas of coverage between the panels and the glass. Accordingly, the combination defroster panel and sunshade will prove to be a most valuable automotive accessory for persons who have occasion to leave their vehicles outdoors, and particularly for those who have limited storage space for various automotive accessories and equipment.

It is to be understood that the present invention is not limited to the embodiments described above, but encompasses any and all embodiments within the scope of the following claims.

I claim:

1. A combination defroster panel and sunshade for vehicle glass, comprising:
at least one rigid panel having a first surface and a second surface opposite the first surface;
an electric heating element disposed on the first surface; and
a reflective coating disposed exteriorly upon the second surface and reflecting outwardly therefrom.

2. The combination defroster panel and sunshade for vehicle glass according to claim 1, further including insulating material disposed upon the first surface at least between the panel and the electric heating element.

3. The combination defroster panel and sunshade for vehicle glass according to claim 1, further including a plurality of attachments disposed upon the first surface and upon the second surface.

4. The combination defroster panel and sunshade for vehicle glass according to claim 3, wherein the attachments are selected from the group consisting of suction cups, hook and loop fastener material, and mechanical fasteners.

5. The combination defroster panel and sunshade for vehicle glass according to claim 1, wherein the at least one rigid panel comprises a plurality of panels pivotally assembled together.

6. The combination defroster panel and sunshade for vehicle glass according to claim 1, wherein the electric heating element comprises a continuous length of electrically resistive wire.

7. The combination defroster panel and sunshade for vehicle glass according to claim 1, wherein the reflective coating comprises an aluminized coating.

8. A combination defroster panel and sunshade for vehicle glass, comprising:
at least one rigid panel having a first surface and a second surface opposite the first surface;
an electric heating element disposed on the first surface;
insulating material disposed between the electric heating element and the rigid panel; and
a reflective coating disposed exteriorly upon the second surface and reflecting outwardly therefrom.

9. The combination defroster panel and sunshade for vehicle glass according to claim 8, further including a plurality of attachments disposed upon the first surface and upon the second surface.

10. The combination defroster panel and sunshade for vehicle glass according to claim 9, wherein the attachments are selected from the group consisting of suction cups, hook and loop fastener material, and mechanical fasteners.

11. The combination defroster panel and sunshade for vehicle glass according to claim 8, wherein the at least one rigid panel comprises a plurality of panels pivotally assembled together.

12. The combination defroster panel and sunshade for vehicle glass according to claim 8, wherein the electric heating element comprises a continuous length of electrically resistive wire.

13. The combination defroster panel and sunshade for vehicle glass according to claim 8, wherein the reflective coating comprises an aluminized coating.

14. A combination defroster panel and sunshade for vehicle glass, comprising:
at least one rigid panel having a first surface and a second surface opposite the first surface;
an electric heating element disposed on the first surface;
a reflective coating disposed exteriorly upon the second surface and reflecting outwardly therefrom; and
a plurality of window attachment mechanisms disposed upon the first surface and upon the second surface.

15. The combination defroster panel and sunshade for vehicle glass according to claim 14, wherein the attachment mechanisms are selected from the group consisting of suction cups, hook and loop fastener material, and mechanical fasteners.

16. The combination defroster panel and sunshade for vehicle glass according to claim 14, further including insulating material disposed upon the first surface at least between the panel and the electric heating element.

17. The combination defroster panel and sunshade for vehicle glass according to claim 14, wherein the at least one rigid panel comprises a plurality of panels pivotally assembled together.

18. The combination defroster panel and sunshade for vehicle glass according to claim 14, wherein the electric heating element comprises a continuous length of electrically resistive wire.

19. The combination defroster panel and sunshade for vehicle glass according to claim 14, wherein the reflective coating comprises an aluminized coating.
